(19) United States
(12) Patent Application Publication
(10) Pub. No.: US 2019/0144606 A1
(43) Pub. Date: May 16, 2019

(54) METHOD OF PRODUCING POWDER-FORM POLYMER USING 1-(p-TOLYLSULFONYL) PYRROLE MONOMER

(71) Applicant: ISTANBUL TEKNIK UNIVERSITESI, Istanbul (TR)

(72) Inventors: A. Sezai SARAC, Istanbul (TR); Ezgi ISMAR, Istanbul (TR)

(73) Assignee: ISTANBUL TEKNIK UNIVERSITESI, Istanbul (TR)

(21) Appl. No.: 16/099,445

(22) PCT Filed: Aug. 24, 2017
(86) PCT No.: PCT/TR2017/050405

§ 371 Date: Nov. 7, 2018

(30) Foreign Application Priority Data
Sep. 7, 2016 (TR) 2016/12648

(51) Int. Cl. C08G 73/06; C08G 61/12; C08G 85/00; H01B 1/12

(52) U.S. Cl. CPC C08G 73/0611; C08G 61/124; C08G 85/002; C08L 33/20; C08G 2261/1452; C08G 2261/3221; H01B 1/127

(57) ABSTRACT

A method of producing powder-form polymer by using 1-(p-tolylsulfonyl)pyrrole monomer. The method includes preparing a solvent and filling it into a reaction vessel, adding polyacrylonitrile (PAN) matrix, surfactant and 1-(p-tolylsulfonyl)pyrrole monomer (M-1pTSP) into the solvent and stirring, adding an initiator onto the resulting mixture so as to initiate the reaction, conducting the chemical polymerization reaction, filtering the product obtained as a result of the reaction, washing and drying the filtrate, and obtaining the polymer mixture containing polyacrylonitrile and poly 1-(p-tolylsulfonyl)pyrrole as the final product.

### CROSS REFERENCE TO THE RELATED APPLICATIONS

This application is the national phase entry of International Application No. PCT/TR2017/050405, filed on Aug. 24, 2017, which claims priority to Turkish Patent Application 2016/12648 filed on Sep. 7, 2016, the entire contents of which are incorporated herein by reference.

### TECHNICAL FIELD

The present invention relates to a method of producing powder-form polymer by using 1-(p-tolylsulfonyl)pyrrole monomer, which method enables to produce conductive polymeric powder in large scale by chemical polymerization of 1-(p-Tolyl sulfonyl)pyrrole monomer in polyacrylonitrile matrix.

### BACKGROUND

Electrochemical polymerization enables, by applying voltage on a mixture (electrolyte) containing monomers, to produce (synthesize) a film coating upon polymerization of the monomers contained in the electrolyte on the anode in the presence of an electrical field. Conductive polymers obtained by electrochemical polymerization method can be produced in very small amounts and produce a fragile film form. Physical and chemical properties of conductive polymers obtained electrochemically bring along restrictions in different and large scale applications. On the other hand, in chemical polymerization, it is possible to obtain the polymer in powder form and preserve it in powder form and use it by variation thereof according to the areas of use.

1-(p-Tolylsulfonyl)pyrrole belongs to the family of monomers of conductive polymers and the empirical formula thereof is C₁₁H₁₁NO₂S. Although there is not a major industrial area of use regarding this monomer yet, it can be used industrially in areas such as antistatic materials, biosensors, display screens, electromagnetic shielding, in which conductive monomers are used and semi-conductivity property thereof can be utilized. It is a monomer which provides electrical conductivity to the polymer material that is produced from itself by means of the tolylsulfonyl functional group it possesses. This monomer is obtained synthetically. It is a commercial monomer which is produced by a chemical reaction and which contains carbon, hydrogen, nitrogen, oxygen and sulfur elements as a result of combination of the pyrrole monomer with sulfonyl group benzene and methyl.

Japanese patent document no. JPS61197636, an application in the state of the art, discloses production of an electrically conductive composite material. Within the scope of the invention, a heterocyclic compound monomer is oxidatively polymerized in the interior of a support and/or on the surface thereof. The monomers used in the material produced by polymerization are pyrrole, thiophene, furan and derivatives thereof. Porous films or sheets composed of fluororesin or polyacrylonitrile composition are used as the supports. The oxidizing agents used for providing the electrical conductivity to the polymer material are highly oxidized oxyacid ions (e.g. S₂O₈⁻² and RuO₄) and ions of acids of noble metals (e.g. PtCl₆⁻² and AuCl₄⁻). In this application, oxidative polymerization of pyrrole derivative monomers are used in the fluororesin and polyacrylonitrile film surfaces.

Japanese patent document no. JP2000336154, an application in the state of the art, discloses a method of producing an electrically conductive polymer material. A polymer having a high electroconductivity is produced by chemical polymerization in order to enable fabricability. In this polymerization method, a monomer (e.g. pyrrole, 3-methylthiophene, 3,4-ethylenedioxythiophene, aniline or the like) in a solution containing an oxidant (e.g. peroxodisulfate, trivalent iron compound, or tetravalent cerium compound such as ceriumsulfate) and at least one type of fluoride selected from the group consisting of a bis(perfluoroalkanesulfonyl)imide, tris(perfluoroalkanesulfonyl)methide, and a salt thereof are used. The reaction is conducted at a temperature of −78 to 50° C., and generally for a period of 1 to 12 hours. In this application, fluoride derivative and salt are used in addition to the chemical polymerization initiator.

Japanese patent document no. JPH05255487, an application in the state of the art, discloses about obtaining a pyrrole polymer, which has excellent mechanical properties and which is useful in many areas such as an electrically conductive material, by carrying out electrolytic polymerization of pyrrole in a medium containing a specific electrolyte. Electrolytic polymerization of pyrrole polymer material is carried out in DMF medium.

### SUMMARY

The objective of the present invention is to provide a method of producing polymer powder enabling to produce a conductive polymer from 1-(p-Tolylsulfonyl)pyrrole monomer, which is a pyrrole derivative, by means of chemical polymerization in large scale and more inexpensively in comparison to the electrochemical polymerization.

Another objective of the present invention is to provide a method of producing polymer powder which enables to provide antistatic and conductivity properties to the polymer structure obtained by the tolylsulfonyl functional group of the sulfonyl group bound to the pyrrole ring.

A further objective of the present invention is to provide a method of producing polymer powder which, by means of chemical polymerization, enables to produce a powder-form polymeric material which is easier to store and has a wider area of use.

### BRIEF DESCRIPTION OF THE DRAWINGS

“Method of Producing Powder-Form Polymer Using 1-(p-Tolylsulfonyl)Pyrrole Monomer” developed to fulfill the objective of the present invention is illustrated in the accompanying figures, in which;

FIG. 1. is a representation of the chemical polymerization reaction carried out within the scope of the invention.

FIG. 2. is a view of the Fourier Transform Infrared Spectroscopy (FTIR) graphic of 1-(p-tolyl sulfonyl)pyrrole monomer.

FIG. 3. is a view of the Fourier Transform Infrared Spectroscopy (FTIR) graphic of the polymer obtained after polymerization.

FIG. 4. is a view of the Ultraviolet Visible Spectroscopy (UV) graphic of the solution of different concentrations after polymerization.

FIG. 5. is a schematic view of the chemical polymerization system in the production process of the present invention.

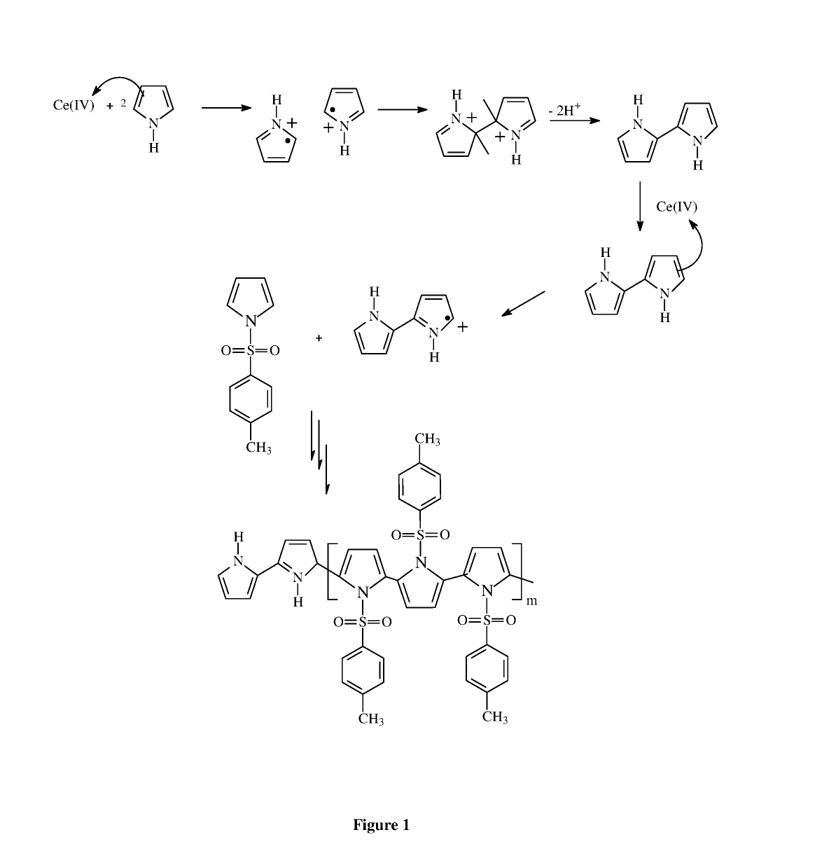

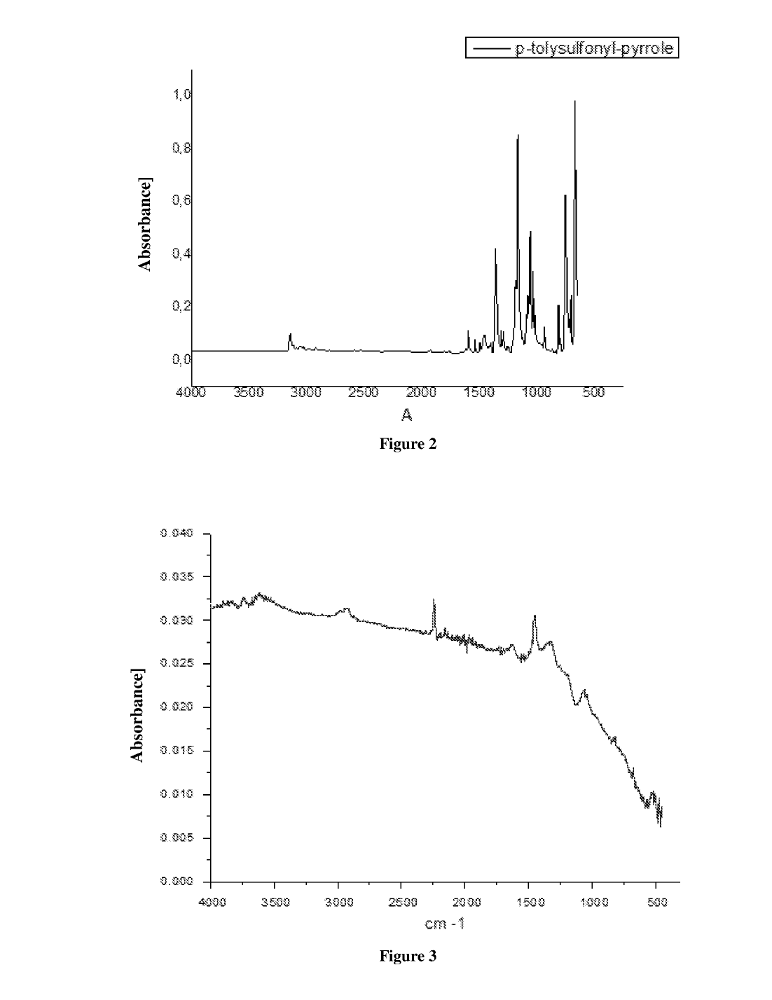

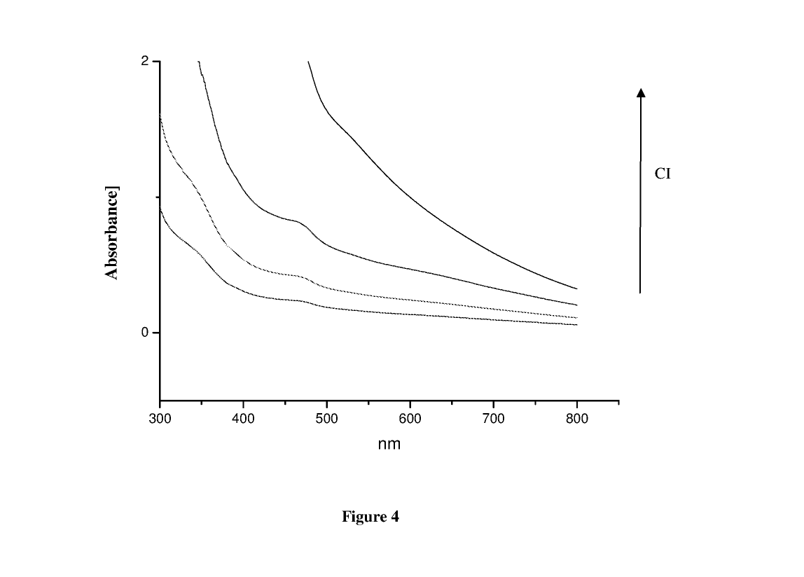

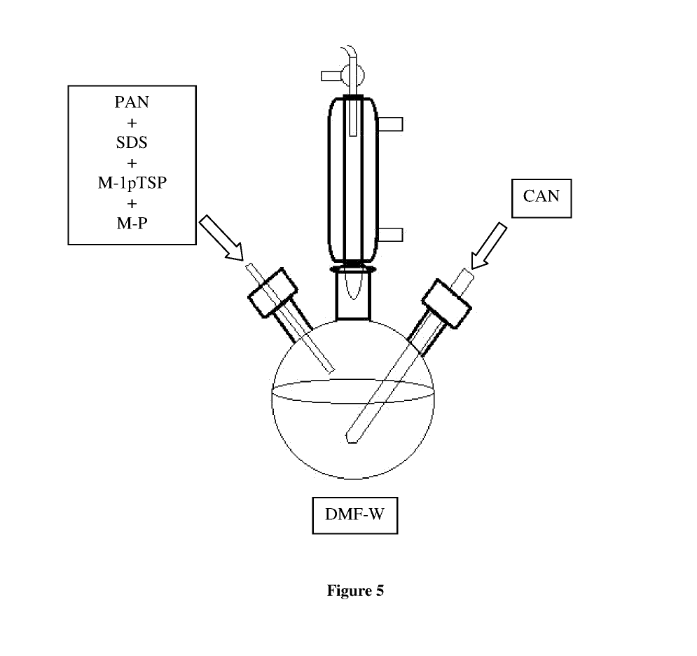

The components shown in the figures are each given reference numbers as follows:
CAN. Ammonium cerium (IV) nitrate [(NH4)2Ce(NO3)6 (Cerium (IV))]
DMF-W. N—N,Dimethyl formamide (DMF)—Water solvent mixture
PAN. Polyacrylonitrile
SDS. Sodiumdodecyl sulfate
M-1pTSP. 1-(p-Tolyl sulfonyl)pyrrole monomer
M-P. Pyrrole monomer
CI. Concentration increase direction

### DETAILED DESCRIPTION OF THE EMBODIMENTS

The present method of producing polymer powder, which enables a conductive polymer material obtained by chemical polymerization of 1-(p-Tolylsulfonyl)pyrrole monomer (M-1pTSP) to be produced in powder form, in large scale and more inexpensively in comparison to conventional applications, comprises the steps of
preparing a solvent and filling it into a reaction vessel,
adding polyacrylonitrile (PAN) matrix, surfactant and 1-(p-tolylsulfonyl)pyrrole monomer into the solvent and stirring,
adding Ammonium cerium (IV) nitrate (CAN) dissolved in water and pyrrole monomer (M-P) onto the resulting mixture as initiator for the reaction to take place,
conducting the chemical polymerization reaction,
filtering the product obtained as a result of the reaction,
washing and drying the filtrate,
obtaining the polymer mixture containing polyacrylonitrile and poly 1-(p-tolylsulfonyl)pyrrole as the final product.

In the present method of producing powder-form polymer using 1-(p-tolylsulfonyl)pyrrole monomer, solution polymerization is performed and a mixture of N—N,Dimethyl formamide (DMF) (30-50 ml) and water (H₂O) (1-3 ml) is used as the solvent. While ammonium cerium (IV) nitrate (CAN) initiator can be easily dissolved in water and then added to the system, it cannot exhibit the same success in N—N,Dimethyl formamide (DMF). Likewise, water cannot enable dissolution of Polyacrylonitrile (PAN) polymer. Therefore N—N,Dimethyl formamide (DMF) medium is preferred for dissolving the polymer. Ammonium cerium (IV) nitrate (CAN) which is used as the initiator is dissolved in water and then added into the N—N,Dimethyl formamide (DMF) medium, thus the solvent (DMF-W) medium is comprised of a mixture of DMF and water. Polymerization is started in the solvent (DMF-W) medium of N—N,Dimethyl formamide containing 4-6% by volume of water and in the presence of Polyacrylonitrile (PAN) matrix. After stirring the components of 0.20-0.30 g sodiumdodecylsulfate (SDS) surfactant, 0.9-1.1 g Polyacrylonitrile (PAN), 0.20-0.30 g 1-(p-Tolylsulfonyl)pyrrole monomer (M-1pTSP) and 30-50 microliter pyrrole monomer (M-P) in DMF for 1-2 hours, the initiator is dissolved in 1.5-2.5 ml water (H₂O) and added to the reaction medium. Using pyrrole monomer (M-P) together with the 1-(p-Tolylsulfonyl)pyrrole monomer, which is intended to be polymerized, exhibited favorable influence in the polymerization reaction enabling the polymerization to start. It was observed in the experimental studies that were conducted that polymerization was not successful independent of the said components. In the scope of the present invention, preferably ammonium cerium (IV) nitrate is used as the initiator. Polymerization duration is set as 1-2 hours and polymerization is conducted by stirring continuously via a magnetic stirrer at room temperature. In order to terminate the polymerization, ethanol is added into the solution at the end of 1-2 hours. Addition of ethanol terminates polymerization, because alcohol structures (R—OH) hinder progress of the bindings by interfering with the progressive polymerization reaction, and thus the progressive chain reactions are terminated. Then, the filtrate obtained by filtering is washed with ethanol and water successively and allowed to dry at room temperature. As a result of the experimental studies performed during development of the invention, the polymerization efficiency was determined as 75-80%.

In the preferred embodiment of the present invention, ammonium cerium (IV) nitrate initiator and pyrrole monomer are used together as the initiator system. First of all, the pyrrole monomer is added to the polymerization medium and then ammonium cerium (IV) nitrate dissolved in water is added to the polymerization medium, and the pyrrole (M-P) and ammonium cerium (IV) nitrate (CAN) combined in the polymerization medium constitute the initiator system. In the experimental studies that were conducted, it was observed that ammonium cerium (IV) nitrate (CAN) was not sufficient to initiate the polymerization reactions, but addition of pyrrole monomer produced a favorable effect for resolution of this problem. Polymerization is realized by elongation of the chain upon easily adding the 1-(p-tolylsulfonyl)pyrrole monomers to the polymerization chains which are initiated by the pyrrole ring. In addition, N—N,Dimethyl formamide (DMF) and water are used together as the chemical polymerization medium.

By means of the present invention, chemical polymerization of 1-(p-Tolylsulfonyl)pyrrole monomer (M-1pTSP) is conducted in the solvent (DMF-W) medium of N—N,Dimethyl formamide containing 4-6% by volume of water and in the presence of Polyacrylonitrile (PAN) matrix. In the scope of the invention, polymerization of 1-(p-Tolylsulfonyl)pyrrole monomer (M-1pTSP) is realized by free radical polymerization in solution. Polyacrylonitrile is used in the polymerization medium and a polymer mixture containing polyacrylonitrile and poly1-(p-tolylsulfonyl)pyrrole is obtained at the end of the polymerization. Physical and chemical properties of the conductive polymers obtained by the electrochemical polymerization in conventional methods bring along restrictions in different and large scale applications. By means of the chemical polymerization method, which is preferred in the scope of the present invention over the conventional electrochemical polymerization method, the polymer powder that is obtained allows use in various applications in forms such as film or fiber. The difference of the 1-(p-Tolylsulfonyl)pyrrole monomer (M-1pTSP), which is used in the scope of the invention and which is a pyrrole derivative, from the pyrrole derivative monomer applications in the art is that since it has tolylsulfonyl functional group, it provides an ionic additive to the pyrrole ring which is superior than the pyrrole monomer.

The initiators (such as Iron (III) ion, cerium (IV), ammoniumpersulfate) used in the conventional applications for chemical polymerization of the pyrrole monomer cannot polymerize 1-(p-Tolyl sulfonyl)pyrrole monomer (M-1pTSP) alone. Accordingly, in the scope of the present invention, chemical polymerization of 1-(p-Tolylsulfonyl)pyrrole monomer (M-1pTSP) is carried out in the presence of cerium (IV)-pyrrole initiator.

In the experimental studies conducted in the scope of the invention, electrochemical polymerization of 1-(p-Tolylsulfonyl)pyrrole monomer was studied as well. It was observed that the amount of production was too low and the production was too costly in the electrochemical polymerization. Thus, it is understood that it is not suitable for large scale synthesis operations. Subsequently, chemical polymerization of 1-(p-Tolylsulfonyl)pyrrole monomer (M-1pTSP) with the cerium (IV)-pyrrole initiator was carried out. The 1-(p-Tolylsulfonyl)pyrrole monomer (M-1pTSP), which is preferred in the scope of the invention, is a pyrrole derivative, and since it has tolylsulfonyl functional group, it provides an ionic additive to the pyrrole ring. Moreover, it has antistatic and conductivity properties due to the presence of the polymeric sulfonyl group obtained by polymerization of 1-(p-Tolylsulfonyl)pyrrole monomer (M-1pTSP) and this property cannot be easily achieved in the other conductive polymers.

Taking into consideration the disadvantages of the electrochemical polymerization method regarding the properties and areas of use of the obtained product, significant advantages are achieved in the polymerization method of the present invention by carrying out chemical polymerization of 1-(p-Tolylsulfonyl)pyrrole monomer (M-1pTSP) with the cerium (IV)-pyrrole initiator. The polymer produced in the scope of the present invention can be obtained in powder form, and this provides a significant advantage over the fragile product obtained by the electrochemical polymerization method. In contrast to the electrochemical polymerization method, the present method enables a lower-cost production in larger quantities which is easier in terms of production amount.

What is claimed is:

1. A method of producing a powder-form polymer using 1-(p-tolylsulfonyl)pyrrole monomer, the method comprising:
preparing a solvent and filling it into a reaction vessel,
adding polyacrylonitrile (PAN) matrix, surfactant and 1-(p-tolylsulfonyl)pyrrole monomer (M-1pTSP) into the solvent and stirring,
adding an initiator onto the resulting mixture so as to initiate the reaction,
conducting the chemical polymerization reaction,
filtering the product obtained as a result of the reaction,
washing and drying the filtrate, and
obtaining the polymer mixture containing polyacrylonitrile and poly 1-(p-tolylsulfonyl)pyrrole as the final product.

2. The method of claim 1, wherein 30-50 ml N—N,Dimethyl formamide (DMF) and 1.5-2.5 ml water are mixed in the step of preparing the solvent.

3. The method of claim 1, wherein 0.20-0.30 g surfactant, 0.9-1.1 g Polyacrylonitrile (PAN) and 0.20-0.30 g 1-(p-Tolyl sulfonyl)pyrrole monomer (M-1pTSP) are added into the solvent.

4. The method of claim 1, wherein 30-50 microliter pyrrole monomer (M-P) is added into the solvent.

5. The method of claim 1, wherein the surfactant is sodiumdodecylsulfate (SDS).

6. The method of claim 1, wherein, in the step of adding the initiator for the reaction to take place, the initiator is added upon being dissolved in 1.5-2.5 ml water.

7. The method of claim 1, wherein the initiator is ammonium cerium (IV) nitrate.

8. The method of claim 1, wherein the initiator is a combination of ammonium cerium (IV) nitrate and pyrrole monomer.

9. The method of claim 1, wherein, in the step of conducting the chemical polymerization reaction, the mixture is stirred continuously at room temperature for 1-2 hours by a magnetic stirrer.

10. The method of claim 1, further comprising, adding ethanol into the solution in order to terminate the polymerization.

11. The method of claim 1, wherein, in the step of washing and drying the filtrate, the filtrate obtained by filtering is washed first with ethanol and then with water and allowed to dry at room temperature.

12. The method of claim 3, wherein 30-50 microliter pyrrole monomer (M-P) is added into the solvent.

13. The method of claim 3, wherein the surfactant is sodiumdodecylsulfate (SDS).

14. The method of claim 6, wherein the initiator is ammonium cerium (IV) nitrate.

15. The method of claim 4, wherein the initiator is a combination of ammonium cerium (IV) nitrate and pyrrole monomer.

16. The method of claim 6, wherein the initiator is a combination of ammonium cerium (IV) nitrate and pyrrole monomer.
